(19) United States
(12) Patent Application Publication
(10) Pub. No.: US 2011/0057014 A1
(43) Pub. Date: Mar. 10, 2011

(54) Nailing Gun Trigger Safety Device and Nailing Gun Provided with the Same

(75) Inventors: Mingjun Yang, Zhejiang (CN); Qicheng Wu, Zhejiang (CN)

(73) Assignee: TAIZHOU DAJIANG IND. CO., LTD., Wenling, Zhejiang (CN)

(21) Appl. No.: 12/990,944

(22) PCT Filed: Jul. 9, 2008
(86) PCT No.: PCT/CN2008/001296

§ 371 Date: Nov. 3, 2010

(30) Foreign Application Priority Data
May 23, 2008 (CN) 200810098212.2

(51) Int. Cl. B25C 1/00

(52) U.S. Cl. 227/8

(57) ABSTRACT

A nailing gun trigger safety device and a nailing gun provided with the same are disclosed. Said nailing gun safety device is provided on the nailing gun body and interconnects with a trigger mechanism. Said nailing gun trigger safety device includes a contact-jacking mechanism and an poking mechanism interconnected with the contact-jacking mechanism. Said contact-jacking mechanism is slidably mounted on the distal end of the nailing body. Said poking mechanism interconnects with the contact-jacking mechanism. Said nailing gun trigger safety device further includes a transmission mechanism interconnected with the trigger mechanism and said transmission mechanism interconnects with said poking mechanism and the trigger mechanism respectively. Such a mechanical structure makes the structure of the nailing gun trigger safety device simple and reduces the manufacture cost.

### FIELD OF THE INVENTION

The invention relates to a trigger safety device, more particularly to a nailing gun equipped with the device.

### BACKGROUND OF THE INVENTION

Owing to convenient carrying and usage, small power tools have become indispensible to various projects such as construction, civil engineering, decoration, etc. Increasing importance is attached to the safety of the power tools in the usage process thereof. In order to avoid that accidental trigger of the nailing gun in the projects accidentally injures people or objects, a trigger safety device is usually required to be arranged on the nailing gun to protect users. In the utility model patent of China (Patent Number: 200620055098.1, Publication Day Feb. 21, 2007), a nailing gun safe device is disclosed, which comprises a pneumatic safety device, a top support device and a driving device, wherein the pneumatic safety device comprises a valve seat and an air valve arranged inside the valve seat and capable of slideable movement in the valve seat; the top support device is linked with the driving device, and by pressing the top support device, the position of the air valve can be limited through the driving device; and two ends of the driving device are respectively linked with the air valve of the pneumatic safety device and the top support device. The nailing gun safety device described in the patent realizes the linkage between the top support device and the pneumatic safety device through the driving device in order to achieve the purpose of protecting users, however, the pneumatic safety device with complex structure of the air circuit and quite high requirement on processing precision needs to be connected with a high pressure air chamber and shunts high pressure air, so the production cost of the nailing gun is increased; in addition, the pneumatic safety device has larger volume and occupied space, increasing the volume and the weight of the entire nailing gun.

Further, a mechanical trigger safety device disclosed in the utility model patent of China (CN2880397Y) includes a slideable push rod protruding in front of a nozzle, when the push rod is pushed backwards to slide backwards, a poking rod pivoted on a gun body is pushed, a rotating component is pushed subsequent to the rotation of the poking rod so as to move away a stop block on a switch. Hence, the nailing gun can achieve triggered only after the push rod at the nozzle is pushed by processed materials, thereby protecting the users. Nevertheless, the structure of this nailing gun is apparently only suitable for electric nailing guns, not for pneumatic nailing guns. Furthermore, such a nailing gun cannot differentiate correct operation sequence, which leads to the fact that the percussion of the nailing gun occurs only if the push rod is pressed and the trigger is pulled, causing danger in some cases. Some users make it a rule to pull the trigger tightly all the time, so the trigger of the nailing gun occurs in case that the nozzle is accidentally touched.

### SUMMARY OF THE INVENTION

The technical problem required to be solved in the invention lies in overcoming the deficiencies in the prior art, and providing A nailing gun trigger safety device and a nailing gun provided with the same with simple structure, convenient use and good safety.

A nailing gun trigger safety device according to the invention comprises a contact-jacking mechanism 20, a poking mechanism 30 linked with the contact-jacking mechanism 20 and a transmission mechanism 40 linked with the poking mechanism 30, wherein the contact-jacking mechanism 20 can be slideably mounted on a nozzle 11 of the nailing gun body 1; and the device is characterized in that: the nailing gun trigger safety device is arranged on the nailing gun body 1 and is linked with a trigger mechanism 50;

the trigger mechanism 50 comprises a trigger 52 and a pressing sheet 51 driven by the trigger, and an air needle 54 for starting up a nailing gun percussion mechanism, wherein the contact-jacking mechanism 20 is linked with the pressing sheet 51 via the poking mechanism 30 and the transmission mechanism 40;

when the contact-jacking mechanism 20 is not pressed, the pressing sheet 51 is positioned at a first initial position and the air needle 54 is beyond the stroke of the pressing sheet 51;

when the contact-jacking mechanism 20 is pressed, the contact-jacking mechanism 20 pushes the pressing sheet 51 to a second initial position via the poking mechanism 30 and the transmission mechanism 40, and the air needle 54 is within the stroke of the pressing sheet 51.

Further, the transmission mechanism 40 comprises a mounting rack 41 suitable for the arrangement on the nailing gun body 1, an L-shaped guide rod 42 and a bending rod 43 articulated with the rear end of the guide rod 42, wherein the middle corner of the L-shaped guide rod 42 is mounted on the mounting rack 41 via a pivot 45, the front end of the guide rod 42 is linked with the poking mechanism 30, and the bending rod 43 is linked with the pressing sheet 51 of the trigger mechanism 50;

the poking mechanism 30 comprises a bracket 31 mounted on the nozzle 11, a fork 32 rotatably mounted on the bracket 31 and an elastic member 33 suitable for being mounted on the bracket 31 and fit with the fork 32, wherein the fork 32 is mounted on slide slot on the bracket 31 via a pivot 34, the elastic member 33 pushes the pivot 34 to the front end of the slide slot; the fork 32 further comprises a front end part linked with the contact-jacking mechanism 20 and a rear end part butting against the rear end of the guide rod 42 of the transmission mechanism 40;

the contact-jacking mechanism 20 comprises a contact-jacking member 23, an anti-pushing member 21 fixed at the tail end of the contact-jacking member 23 and an elastic member 22 arranged between the anti-pushing member 21 and the contact-jacking member 23, wherein the contact-jacking member 23 can be slideably mounted on the nozzle 11, and the anti-pushing member 21 butts against the front end part of the fork 32 of the poking mechanism 30.

The nailing gun equipped with the nailing gun trigger safety device is characterized in that: the nailing gun comprises the gun body and the nailing gun trigger safety device.

Under the initial situation, the pressing sheet is positioned at the first initial position and the air needle is beyond the stroke of the pressing sheet. In this case, pulling the trigger cannot lead to the percussion of the nailing gun.

When being pressed, the contact-jacking mechanism pushes the front end part of the fork 32, and since the pivot 34 of the fork 32 is pushed by the elastic member 33 and accordingly maintained at the front ends of the slide slots, the fork 32 can rotate only. The rear end part of the fork 32 presses the front end of the guide rod 42, and after the guide rod 42 rotates, the rear end thereof drives the bending rod 43 to move backwards. The bending rod 43 pushes the pressing sheet 51 to the second initial position, and the air needle 54 is within the stroke of the pressing sheet 51. In this case, the air needle 54 can be triggered by the pressing sheet 51 by pulling the trigger again.

If the trigger is pulled at first and the contact-jacking mechanism is pressed subsequently, just as the bad habit of some users of pulling the trigger tightly all the time, the percussion of the nailing gun cannot occur. Under the situation that the contact-jacking mechanism at the front part of the nozzle is not pressed, after the trigger is pulled, the pressing sheet 51 pushes the bending rod 43 to move forwards, the guide rod rotates clockwise to push the fork to rotate counterclockwise, and the front end part of the fork pushes the contact-jacking mechanism to move forwards, thereby achieving the effect that the pressing sheet 51 pushes the transmission mechanism 40 and the poking mechanism 30, the front end of the contact-jacking mechanism 20 is not fixed yet at this moment and pushed towards the front end of the nozzle 11 under the pushing of the poking mechanism 30. In this case the air needle is beyond the stroke of the pressing sheet, and can't been triggered.

The contact-jacking mechanism 20 is then pressed, and since the transmission mechanism 40 is obstructed by the air pressure of the switch, the pivot 34 of the fork 32 neutralizes the resistance of the elastic member 33 to move backwards inside the slide slot of the bracket 31, neither poking the transmission mechanism 40 nor pushing the pressing sheet 51 of the switch to cause percussion.

The nailing gun equipped with the safe device according to the invention can achieve percussion only according to correct operation sequence, enhancing the safety of the nailing gun.

Compared with the prior art, a nailing gun trigger safety device and a nailing gun equipped with the device according to the invention at least have the following advantages:

1. A nailing gun trigger safety device provided by the invention is provided with a poking device and a transmission device between the contact-jacking mechanism and the trigger mechanism, such a mechanical structure enables the nailing gun trigger safety device to simple structure, thereby reducing the manufacturing cost of the nailing gun.

2. A nailing gun trigger safety device provided by the invention adopts the mechanical structure, which diminishes the occupied space of the nailing gun trigger safety device and the volume of the nailing gun, as well as reduces the weight of the nailing gun.

3. Better safety.

Partial description regarding advantages of the invention in additional aspects is given in the following embodiments, and the advantages become more apparent in the description below, or understandable through practices of the invention.

### BRIEF DESCRIPTION OF THE DRAWINGS

The advantages of the invention become apparent and easy for understanding in the description below with reference to the attached drawings, wherein:

FIG. 1 is a schematic diagram of the disassembled nailing gun trigger safety device according to the invention.

FIG. 2 is a sectional view of the nailing gun trigger safety device according to the invention in an original state.

FIG. 3 is a sectional view of the nailing gun trigger safety device according to the invention in an untargeted percussion state.

FIG. 4 is a sectional view of the nailing gun trigger safety device according to the invention in an untargeted percussion-subsequent backpressure state.

FIG. 5 is a sectional view of the nailing gun trigger safety device according to the invention in a percussion state.

### DETAIL DESCRIPTION OF THE INVENTION

Detailed description is made to the embodiments of the invention, and examples of the embodiments are shown in the attached drawings, with the same mark number always representing the same element. The explanation of the invention is given below through the embodiments described with reference to the attached drawings, and the embodiments, which are exemplary, cannot be explained to the limitation for the invention.

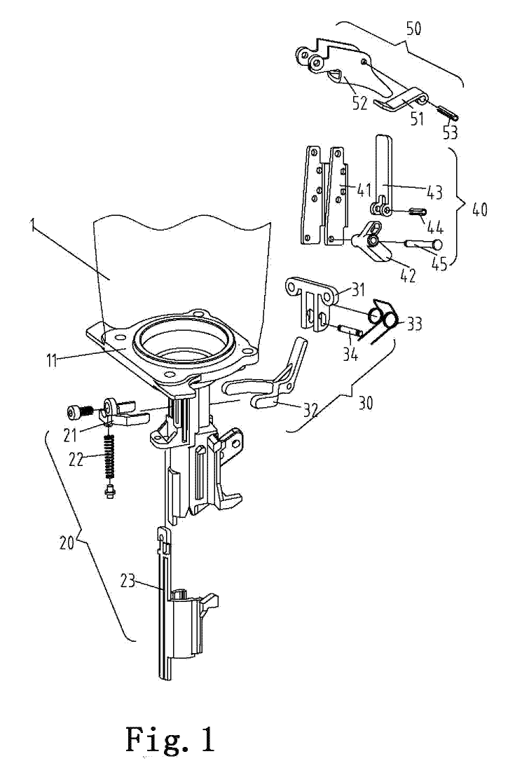

With reference to the FIG. 1, the nailing gun trigger safety device is arranged on the nailing gun body 1 and is linked with the trigger mechanism 50, what needs to explain is that the linkage herein means the junction of the safe device and the trigger mechanism 50 can move as the trigger mechanism 50 moves during the movement of the trigger, so as to drive the entire nailing gun trigger safety device to move. For example, the trigger mechanism comprises a trigger 52, a pressing sheet 51, a pivot 53, and an air needle 54 for starting up the nailing gun percussion mechanism, the trigger 52 can be rotatably fixed to the nailing gun body 1 and is connected with the pressing sheet 51 via the pivot 53, and when the trigger 52 is pulled, the pressing sheet 51 can press the junction thereof with the nailing gun trigger safety device. Specific connection way and operating process are described below. The nailing gun trigger safety device comprises a contact-jacking mechanism 20 and a poking mechanism 30 linked with the contact-jacking mechanism 20, the contact-jacking mechanism 20 can be slideably mounted on the nozzle 11 of the nailing gun body 1, the poking mechanism 30 is linked with the contact-jacking mechanism 20, the nailing gun trigger safety device further comprises a transmission mechanism 40 linked with the trigger mechanism 50, and the transmission mechanism 40 is respectively linked with the poking mechanism 30 and the trigger mechanism 50.

With reference to the FIG. 1, according to the above embodiment of the invention, the transmission mechanism 40 comprises a mounting rack 41 suitable for the arrangement on the nailing gun body 1, an guide rod 42 movably mounted on the mounting rack 41 and a bending rod 43 linked with the guide rod 42, the guide rod 42 is linked with the poking mechanism 30, and the bending rod 43 is linked with the trigger mechanism 50. When the trigger mechanism 50 moves, the poking mechanism 30 can generate movement through the linkage thereof with the transmission mechanism 40, in the same way, when the contact-jacking mechanism 20 moves, the trigger mechanism is maintained in certain state by means of the linkage of the poking mechanism 30 and the transmission mechanism 40.

With reference to the FIG. 1, according to the above embodiment of the invention, the guide rod 42 is mounted on the mounting rack 41 in an articulated manner. The guide rod 42 is connected with the bending rod 43 via a pivot 44. Specifically, the rear end of the guide rod 42 is connected with the front end of the bending rod 43 via a pivot 45, and the bending rod 43, when moving back and forth along the mounting rack, can drive the guide rod 42 to rotationally move simultaneously. The bending rod 43 is linked with the trigger mechanism 50, and the guide rod 42 is linked with the poking mechanism 30, in this case, the linkage of the trigger mechanism 50 and the poking mechanism 30 is completed via the guide rod 42 and the bending rod 43, thereby further achieving the linkage of the trigger mechanism 50 and the contact-jacking mechanism 20. Specifically, the contact-jacking mechanism 20 is linked with the pressing sheet 51 via the poking mechanism 30 and the transmission mechanism 40.

With reference to the FIG. 1, according to the above embodiment of the invention, the guide rod 42 is L-shaped, the rear end of the L-shaped guide rod 42 is linked with the bending rod 43, the left side part of the front end of the L-shaped guide rod is linked with the poking mechanism 30, and the middle corner of the L-shaped guide rod is mounted on the mounting rack 41 via the pivot 44. The L shape of the guide rod 42 lengthens the moving distance of the guide rod 42 and the poking mechanism 30 and also enhances the flexibility of the trigger safety device.

With reference to the FIG. 1, according to the embodiments of the invention, the poking mechanism 30 comprises a bracket 31 suitable for being mounted on the nozzle 11, a fork 32 rotatably mounted the bracket 31 and an elastic member 33 suitable for being mounted on the bracket 31 and fit with the fork 32. More specifically, the fork 32 is mounted on the bracket 31 via the pivot 34, and comprises a front end part linked with the contact-jacking mechanism 20 and a rear end part linked with the transmission mechanism 40. The contact-jacking mechanism 20 comprises a contact-jacking member 23, an anti-pushing member 21 fixed at the tail end of the contact-jacking member 23 and an elastic member 22 arranged between the anti-pushing member 21 and the contact-jacking member 23, the contact-jacking member 23 can be slidably mounted on the nozzle 11 and the anti-pushing member 21 is linked with the poking mechanism 30. The bracket 31 is fixed on the nozzle 11 and is provided with symmetrical slide slots at the front end thereof, the fork 32 is connected to the slide slots of the bracket 31 via the pivot 34, the front end is erected at two sides of the nozzle 11 in a forked manner and is clamped with the anti-pushing member 21 of the contact-jacking mechanism 20 to achieve linkage, the middle of the bracket 31 is provided with an elastic member 33, through which elastic force is offered to realize push-against so that the pivot 34 moves, while retracting, towards the front end of the nozzle 11 in case that no external force is applied.

With reference to the FIG. 1, a nailing gun provided with trigger safety device according to the invention comprises a nailing gun body 1 and a trigger safety device suitable for being mounted on the nailing gun body 1, the nailing gun trigger safety device is arranged on the nailing gun body 1 and is linked with a trigger mechanism 50, the nailing gun trigger safety device comprises a contact-jacking mechanism 20 and a poking mechanism 30 linked with the contact-jacking mechanism 20, the contact-jacking mechanism 20 can be slideably mounted on a nozzle 11 of the nailing gun body 1, the poking mechanism 30 is linked with the contact-jacking mechanism 20, the nailing gun trigger safety device further comprises a transmission mechanism 40 linked with the trigger mechanism 50, and the transmission mechanism 40 is respectively linked with the poking mechanism 30 and the trigger mechanism 50.

With reference to the FIG. 1, according to the embodiments of the invention, the transmission mechanism 40 comprises a mounting rack 41 suitable for the arrangement on the nailing gun body 1, a guide rod 42 movably mounted on the mounting rack 41 and a bending rod 43 linked with the guide rod 42, the guide rod 42 is linked with the poking mechanism 30, and the bending rod 43 is linked with the trigger mechanism 50.

When the contact-jacking mechanism 20 is not pressed, the pressing sheet 51 is positioned at a first initial position and the air needle 54 is beyond the stroke of the pressing sheet. In this case, the trigger 52 is pulled, although the pressing sheet 51 finishes the stroke, the air needle 54 is beyond the stroke thereof, therefore, the air needle cannot be triggered.

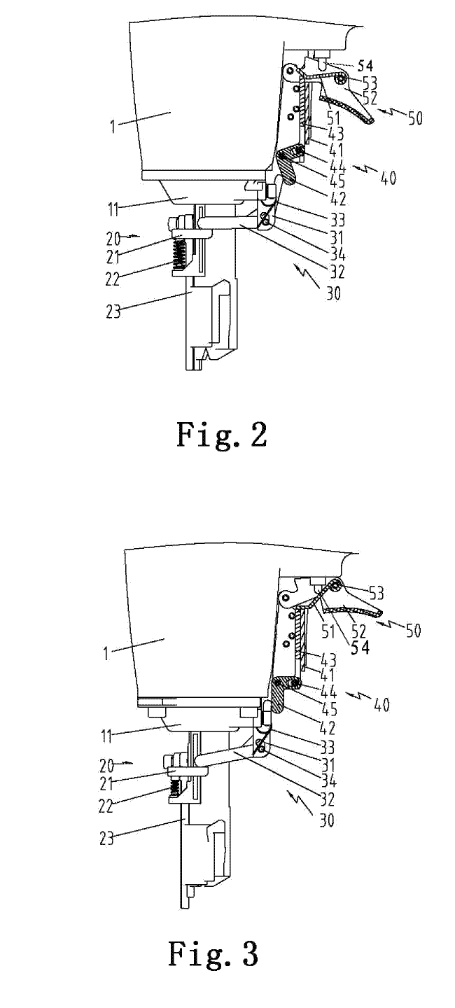

With reference to the FIG. 2, when the trigger mechanism 50 is released, the contact-jacking mechanism 20 retracts towards the nailing gun body 1 under the push-against of the elastic member 22 and simultaneously pushes the poking mechanism 30 and the transmission mechanism 40 so as to push the pressing sheet 51 to a second initial position, and the air needle 54 is within the stroke of the pressing sheet 51.

Specifically, When being pressed, the contact-jacking mechanism 20 pushes the front end part of the fork 32, and since the pivot 34 of the fork 32 is pushed by the elastic member 33 and accordingly maintained at the front ends of the slide slots 35, the fork 32 can rotate only. The rear end part of the fork 32 presses the front end of the guide rod 42, and after the guide rod 42 rotates, the rear end thereof drives the bending rod 43 to move backwards. The bending rod 43 pushes the pressing sheet 51 to the second initial position, and the air needle 54 is within the stroke of the pressing sheet 51. Afterwards, the air needle 54 is triggered by the pressing sheet by pulling the trigger 52 again.

With reference to the FIG. 3, when the trigger mechanism 50 is triggered in case that the contact-jacking mechanism 20 is not pressed, the pressing sheet 51 pushes the transmission mechanism 40 and the poking mechanism 30, the front end of the contact-jacking mechanism 20 is not fixed at this moment and is pushed towards the front end of the nozzle 11 under the pushing of the poking mechanism 30, and percussion cannot occur at this moment as the switch is not opened.

Specifically, under the situation that the contact-jacking mechanism 20 at the front part of the nozzle is not pressed, after the trigger 52 is pulled, the pressing sheet 51 pushes the bending rod 43 to move forwards, the guide rod 42 rotates clockwise to push the fork to rotate counterclockwise, and the front end part of the fork pushes the contact-jacking mechanism to move forwards, thereby achieving the effect that the pressing sheet 51 pushes the transmission mechanism 40 and the poking mechanism 30, the front end of the contact-jacking mechanism 20 is not fixed yet at this moment and pushed towards the front end of the nozzle 11 under the pushing of the poking mechanism 30. In this case, the air needle is positioned beyond the stroke of the pressing sheet 51 and cannot be triggered accordingly.

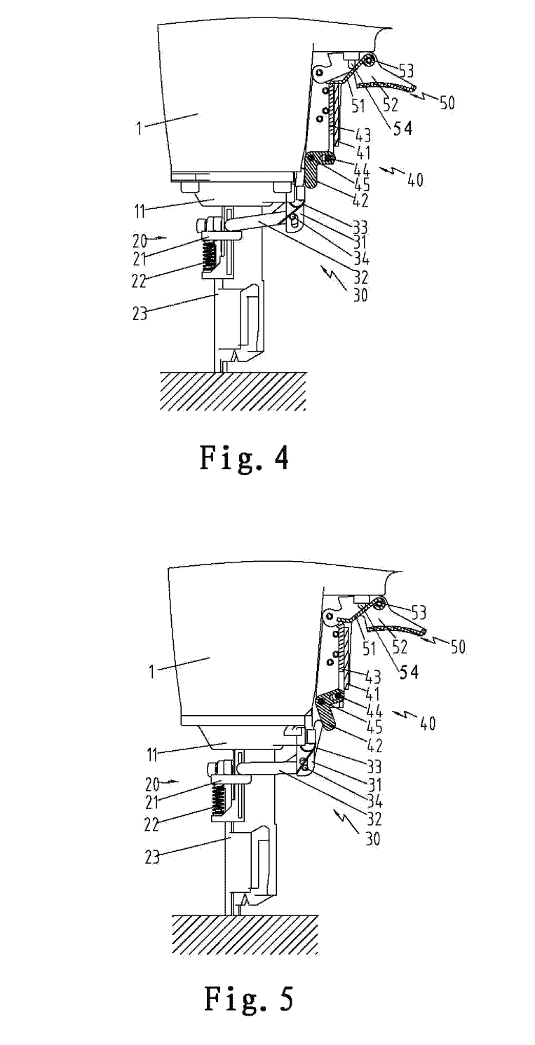

With reference to the FIG. 4, the contact-jacking mechanism 20 is pressed when being positioned at the position shown in the FIG. 3, and since the transmission mechanism 40 is obstructed under the air pressure of the switch at this moment, the poking mechanism 40 moves backwards along the slide slots of the bracket 31 neither poking the transmission mechanism 40 nor pushing the switch to cause percussion.

What is shown in the FIG. 4 is regarded as further state of the state shown in the FIG. 3, under the situation that the contact-jacking mechanism 20 at the front part of the nozzle is not pressed, the trigger 52 is pulled and the contact-jacking mechanism is then pressed. And since the transmission mechanism 40 is obstructed under the air pressure of the switch at this moment, the pivot 34 of the fork 32 neutralizes the resistance of the elastic member 33 to move backwards inside the slide slots of the bracket 31, neither poking the transmission mechanism 40 nor pushing the pressing sheet 51 of the switch to cause percussion.

Thus, it is obvious that the nailing gun equipped with the safe device according to the invention can achieve percussion only according to correct operation sequence, thereby enhancing the safety of the invention. With reference to the FIG. 5, when the contact-jacking mechanism 20 cannot be pushed forwards as the front end thereof is adhered to the working surface of an applied position, the contact-jacking mechanism 20 pushes the pressing sheet 51 to the second initial position via the poking mechanism 30 and the transmission mechanism 40, and the air needle 54 is within the stroke of the pressing sheet. The switch is opened just by pulling the trigger mechanism 50 so as to cause percussion.

It is noteworthy that the detailed description specifically illustrates the technical proposals of the present patent application with the embodiments, however, the skilled in the art easily thinks of the detailed description, and changes and modifies the technical proposals of the present patent application based thereon, but not breaking away from a range summarized by the claims which are requested for protection by the present invention.

1. A nailing gun trigger safety device, comprising a contact jacking mechanism (20), a poking mechanism (30) linked with the contact jacking mechanism (20) and a transmission mechanism (40) linked with the poking mechanism (30), the contact jacking mechanism (20) can be slideably mounted on a nozzle (11) of the nailing gun body (1); and characterized in that: the nailing gun trigger safety device is arranged on the nailing gun body (1) and is linked with a trigger mechanism (50);
the trigger mechanism (50) comprises a trigger and a pressing sheet driven by the trigger, and an air needle for starting up a nailing gun percussion mechanism, the contact jacking mechanism (20) is linked with the pressing sheet via the poking mechanism (30) and the transmission mechanism (40);
when the contact jacking mechanism (20) is not pressed, the pressing sheet is positioned at a first initial position and the air needle is beyond the stroke of the pressing sheet;
when the contact-jacking mechanism (20) is pressed, the contact-jacking mechanism (20) pushes the pressing sheet to a second initial position via the poking mechanism (30) and the transmission mechanism (40) and the air needle is within the stroke of the pressing sheet.

2. The nailing gun trigger safety device according to claim 1, characterized in that: the transmission mechanism (40) comprises a mounting rack (41) suitable for the arrangement on the nailing gun body (1), an L-shaped guide rod (42) and a bending rod (43) articulated with the rear end of the guide rod (42), the middle corner of the L-shaped guide rod (42) is mounted on the mounting rack (41) via a pivot (45), the front end of the guide rod (42) is linked with the poking mechanism (30), and the bending rod (43) is linked with the pressing sheet of the trigger mechanism (50);
the poking mechanism (30) comprises a bracket (31) mounted on the nozzle (11), a fork (32) rotatably mounted on the bracket (31) and an elastic member (33) suitable for being mounted on the bracket (31) and fit with the fork (32), the fork (32) is mounted on a slide slot on the bracket (31) via a pivot (34), the elastic member (33) pushes the pivot (34) to the front end of the slide slot; the fork (32) further comprises a front end part linked with the contact jacking mechanism (20) and a rear end part butting against the rear end of the guide rod (42) of the transmission mechanism (40);
the contact jacking mechanism (20) comprises a contact jacking member (23), an anti-pushing member (21) fixed at the tail end of the contact jacking member (23) and an elastic member (22) arranged between the anti-pushing member (21) and the contact-jacking member (23), the contact jacking member (23) can be slideably mounted on the nozzle (11) and the anti-pushing member (21) butts against the front end part of the fork (32) of the poking mechanism (30).

3. A nailing gun provided with the nailing gun trigger safety device according to claim 1, characterized in that: the nailing gun comprises the gun body and the nailing gun trigger safety device.

4. A nailing gun provided with the nailing gun trigger safety device according to claim 2, characterized in that: the nailing gun comprises the gun body and the nailing gun trigger safety device.
